(19) United States
(12) Patent Application Publication
(10) Pub. No.: US 2009/0179610 A1
(43) Pub. Date: Jul. 16, 2009

(54) MOBILE POWER BANK

(75) Inventor: Hsi-Tung LIN, TAIPEI (TW)

Correspondence Address: Chih Feng Yeh;BRIAN M. MCINNIS, 12th Floor, Ruttonjee House, 11 Duddell Street, Hong Kong, HK

(73) Assignee: Hsi-Tung LIN, TAIPEI CITY (TW)

(21) Appl. No.: 12/245,775

(22) Filed: Oct. 6, 2008

(30) Foreign Application Priority Data
Jan. 15, 2008 (TW) 97200936

(51) Int. Cl. H02J 7/00

(52) U.S. Cl. 320/101; 320/107

(57) ABSTRACT

The invention provides a mobile power bank for charging a portable electronic device. The mobile power bank includes a casing, a printed circuit board disposed in the casing, a rechargeable battery disposed in the casing and electrically connecting to the printed circuit board, a curly transmission wire, and an adapter tip. The curly transmission wire passes through the casing and electrically connects to the rechargeable battery via the printed circuit board. The adapter tip is coupled to the curly transmission wire and electrically connecting to the portable electronic device.

### RELATED APPLICATIONS

This application claims priority to Taiwan Application Serial Number 97200936, filed Jan. 15, 2008, which is herein incorporated by reference.

### BACKGROUND

1. Field of Invention

The present invention relates to electronic device. More particularly, the present invention relates to a power bank.

2. Description of Related Art

Since the introduction of personal computer (PC) systems, different kinds of electronic products have been invented. PC systems have evolved into modern electronic products that are now able to perform many functions, including playing video and audio clips, processing images, and network communications. However, due to the inconvenience resulted from their large volumes and weights, many portable electronic devices with different functions have been introduced, such as MP3 music players, digital cameras, mobile phones, and personal digital assistants (PDA).

The rechargeable battery that has a large electricity capacity and a long duration time, has been widely used in various portable electronic devices. Different kinds of portable electronic devices have their own suitable rechargeable batteries, such as a nickel-cadmium cell, a nickel-metal-hydride battery (NiMH battery), or a lithium cell. The rechargeable batteries need to be charged to provide power to the portable electronic devices being coupled. However, the portable electronic devices cannot operate when the batteries thereof are discharged.

### SUMMARY

The invention provides a mobile power bank for charging a portable electronic device. The mobile power bank includes a casing, a printed circuit board disposed in the casing, a rechargeable battery disposed in the casing and electrically connected to the printed circuit board, a curly transmission wire, and an adapter tip. The curly transmission wire has a first adapting end, and a fixing end passing through the casing and electrically connecting to the rechargeable battery via the printed circuit board. The adapter tip has a second adapting end connecting to the first adapting end, and a coupling end for electrically connecting to the portable electronic device.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a first embodiment of a mobile power bank of the invention;

FIG. 2 is a schematic diagram of a second embodiment of the mobile power bank of the invention; and

FIG. 3 is a side view diagram of a third embodiment of the mobile power bank of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

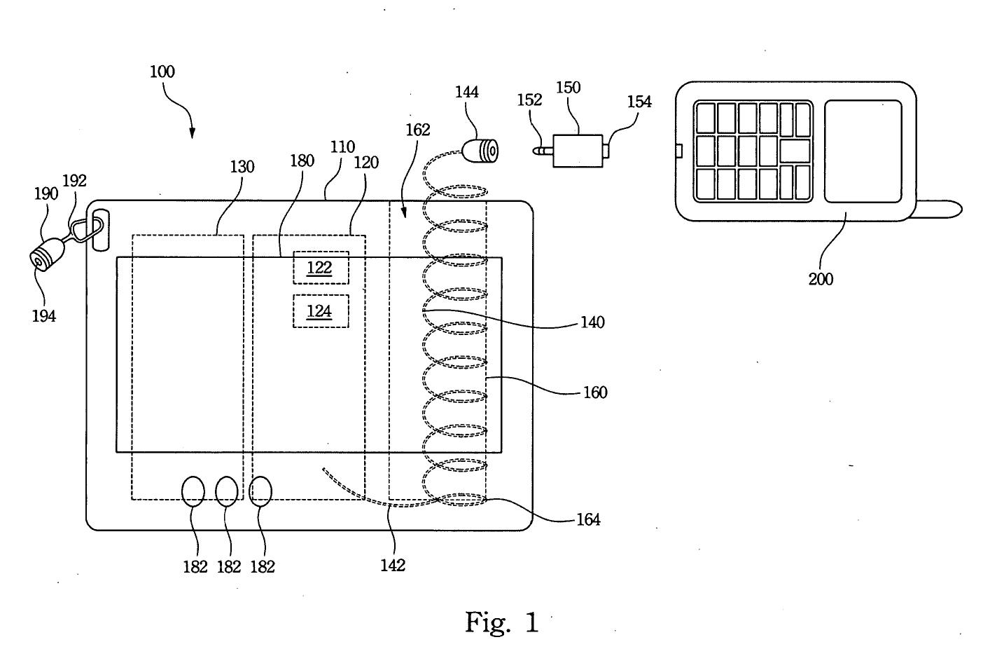

Refer to FIG. 1. FIG. 1 illustrates a schematic diagram of a first embodiment of the mobile power bank of the invention. The mobile power bank 100 can charge a portable electronic device 200. The mobile power bank 100 includes a casing 110, a printed circuit board 120 disposed in the casing 110, a rechargeable battery 130 disposed in the casing 110, a curly transmission wire 140, and an adapter tip 150.

The rechargeable battery 130 is electrically connecting to the printed circuit board 120. The curly transmission wire 140 has a fixing end 142 and a first adapting end 144. The fixing end 142 can be fixed on the casing and connected to the printed circuit board 120. The fixing end 142 is electrically connected to the rechargeable battery 130 via the printed circuit board.

The adapter tip 150 includes a second adapting end 152 and a coupling end 154. The second adapting end 154 is connected to the first adapting end 144 to electrically connect the curly transmission wire 140 and the adapter tip 150. The type of the coupling end 154 of the adapter tip 150 is corresponding to the portable electronic device 200. The rechargeable battery 130 can be a nickel-cadmium cell, a nickel-metal-hydride battery (NiMH battery), a lithium cell, or any reusable battery.

The electric power stored in the rechargeable battery 130 can be sent to the curly transmission wire 140 via the printed circuit board 120, and the electric power can be further sent to the portable electronic device 200 from the curly transmission wire 140 through the adapter tip 150. The portable electronic device 200 can be charged by the mobile power bank 100.

The mobile power bank 100 further includes several light-emitting components 182. The light emitting components 182 are disposed on an outer surface of the casing 110. The light-emitting components 182 are controlled by the printed circuit board 120.

The mobile power bank 100 further includes a solar cell 180 disposed on the outer surface of the casing 110. The solar cell 180 can collect and transfer the solar energy into electricity power. The printed circuit board 120 includes a voltage regulator. The electric power provided by the solar cell 180 is regulated by the voltage regulator, and the regulated electric power is sent and stored in the rechargeable battery 130. The solar cell 180 can be detachably connected to the casing 110 in other embodiments.

The printed circuit board 120 includes a protection circuit. The protection circuit is electrically connected to the rechargeable battery 130 to prevent the rechargeable battery 130 from over-charging or over-discharging.

The mobile power bank 100 includes a tubular cavity 160 disposed on the casing 110. The tubular cavity 160 has an opening 162 and a bottom 164. The fixing end 142 of the curly transmission wire 140 passes through the bottom 164 and electrically couples the printed circuit board 120. The curly transmission wire 140 can be contained in the tubular cavity 160 when the mobile power bank 100 is not in use. The first adapting end 144 of the curly transmission wire 140 can be drawn out from the tubular cavity 160, and coupled to the adapter tip 150.

The mobile power bank 100 includes a cap 190. The cap 190 caps the adapter tip 150 when the adapter tip 150 is not in use. The cap 190 has a mounting portion 194 corresponding to the second adapting end 152 of the adapter tip 150 to tightly couple the cap 190 to the adapter tip 150. The mounting portion 192 is a male plug when the second adapting end 152 is a female plug. The mounting portion 192 is a female plug when the second adapting end 152 is a male plug.

The cap 190 further has a fastener 192. The fastener 192 can fasten the cap 190 on the casing 110. The mobile power bank 100 can charge various kinds of portable electronic devices 200, thus the mobile power bank 100 could have different adapter tips 150 corresponding to the portable electronic devices 200 thereof. The user could choose the adapter tips 150 corresponding to the portable electronic devices 200, and those adapter tips 150 can be coupled to the caps 190 and fastened on the casing 110 by the fasteners 192. The charging voltage, i.e, the voltage level used to charge the rechargeable battery, can be altered by the printed circuit board 120 to charge different portable electronic devices 200.

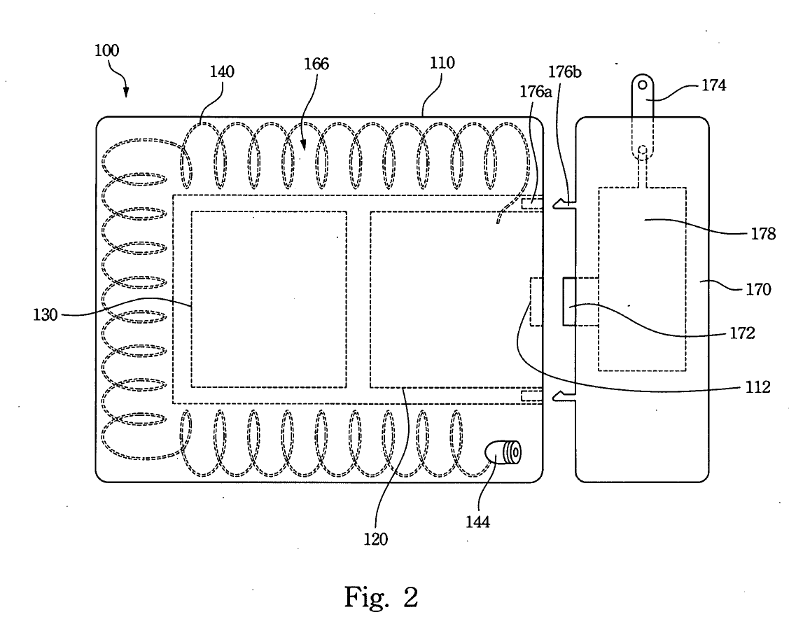

Refer to FIG. 2. FIG. 2 illustrates a schematic diagram of a second embodiment of the mobile power bank of the invention. The mobile power bank 100 includes a fillister 166 disposed on a side surface of the casing 110. The fixing end 142 of the curly transmission wire 140 may pass through an end of the fillister 166 and electrically couple the printed circuit board 120. The curly transmission wire 140 can be contained in the fillister 166 when the curly transmission wire 140 is not in use. The curly transmission wire 140 can be moved from the fillister 166 to expose the first adapting end 144, and the curly transmission wire 140 can couple and charge the portable electronic device (not shown).

The mobile power bank 100 can further include a detachable AC/DC adapter 170. The detachable AC/DC adapter 170 has a plug 174 and an adapter printed circuit board 178. The plug 174 can plug into an AC current source, and the AC current can be converted and transformed to a charging DC current by the adapter printed circuit board 178 to charge the rechargeable battery 130 of the mobile power bank 100.

The casing 110 of the mobile power bank 100 has a first transmission interface 112, and the first transmission interface 112 is electrically coupled to the printed circuit board 120. The detachable AC/DC adapter 170 has a second transmission interface 172. The second transmission interface 172 can couple and electrically connect the first transmission interface 112. The first transmission interface 112 and the second transmission interface 172 can be a universal serial bus (USB) interface.

The detachable AC/DC adapter 170 can have a first coupling portion 176a, and the casing 110 can have a second coupling portion 176b to detachably couple the detachable AC/DC adapter 170 to the casing 110. The first coupling portion 176a can be a hole, and the second coupling portion 176b can be a wedge-like protrusion.

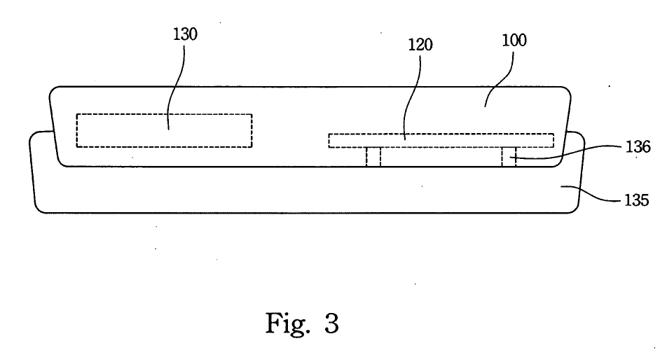

Refer to FIG. 3. FIG. 3 illustrates a side view diagram of a third embodiment of the mobile power bank of the invention. The mobile power bank 100 can further include an extension rechargeable battery 135 to enlarge the charge capacity. The extension rechargeable battery 135 is detachably coupled to the casing 110. The extension rechargeable battery 135 has a connecting structure 136 to electrically connect to the printed circuit board 120. The capacity of the extension rechargeable battery 135 is larger than the capacity of the rechargeable battery 130. The enlarged charge capacity provided by the extension rechargeable battery 135 and the rechargeable battery 130 of the mobile power bank 100 can charge a larger portable electronic device, such as a notebook computer.

The adapter tip of the mobile power bank can be selected according to the portable electronic device, which would be charged by the mobile power bank, thus the mobile power bank can charge different kinds of portable electronic devices. The rechargeable battery of the mobile power bank can be charged by the solar cell or the AC current source. The curly transmission wire, the cap, and the adapter tip can be fastened on the casing, and the mobile power bank can be carried easily.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile power bank for charging a portable electronic device, the mobile power bank comprising:
a casing;
a printed circuit board disposed in the casing;
a rechargeable battery disposed in the casing and electrically connecting to the printed circuit board;
a curly transmission wire having a first adapting end, and a fixing end passing through the casing and electrically connecting to the rechargeable battery via the printed circuit board; and
an adapter tip having a second adapting end connecting to the first adapting end, and a coupling end for electrically connecting to the portable electronic device.

2. The mobile power bank of claim 1, further comprising a tubular cavity disposed on the casing and having an opening and a bottom, wherein the fixing end of the curly transmission wire passes through the bottom and electrically connects to the printed circuit board

3. The mobile power bank of claim 1, further comprising a detachable AC/DC adapter coupling to the casing and having a transmission interface for electrically connecting to the printed circuit board.

4. The mobile power bank of claim 3, wherein the transmission interface is a universal serial bus (USB) interface.

5. The mobile power bank of claim 3, wherein the detachable AC/DC adapter has a plug.

6. The mobile power bank of claim 1, further comprising a fillister disposed on a side surface of the casing, wherein the curly transmission wire is contained in the fillister.

7. The mobile power bank of claim 1, further comprising a solar cell disposed on an outer surface of the casing and electrically connecting to the printed circuit board for charging the rechargeable battery.

8. The mobile power bank of claim 7 wherein the printed circuit board comprises a voltage regulator.

9. The mobile power bank of claim 1, further comprising a cap to cap the second adapting end of the adapter tip.

10. The mobile power bank of claim 1, further comprising a plurality of light-emitting components disposed on an outer surface of the casing and electrically connecting to the printed circuit board.

11. The mobile power bank of claim 1, wherein the printed circuit board comprises a protection circuit to prevent the rechargeable battery from over-charging or over-discharging.

12. The mobile power bank of claim 1 further comprises an extension rechargeable battery electrically connecting to the printed circuit board.
